(19) United States
(12) Patent Application Publication
(10) Pub. No.: US 2011/0319002 A1
(43) Pub. Date: Dec. 29, 2011

(54) Seafood Spitter

(76) Inventors: Pamela Myers, Bunkie, LA (US); Michael Powell, Chicago, IL (US)

(21) Appl. No.: 12/775,634

(22) Filed: Jun. 23, 2010

(51) Int. Cl. A22C 29/00

(52) U.S. Cl. 452/6

(57) ABSTRACT

I have designed a new product called the ‘Seafood Spitter’. The purpose of this invention is to clean seafood, specifically crawfish and crabs, in less time and a more efficient manner prior to cooking.

Cleaning seafood is a time consuming, cumbersome task that requires soaking in salt water a minimum of three times to remove unwanted byproducts such as dirt and grass.

To accomplish this soaking successfully, most people must use two or more beverage coolers. Emptying these coolers is an awkward process as well since they are heavy when they are full to capacity. Additionally, they require an inordinate amount of time to drain once the cleaning process is complete. The process is even longer for users who do not have coolers with drainage spouts.

This is where my Seafood Spitter comes in. It is made of a lightweight plastic, which allows for easier handling and lifting. It is a two part device and it should be used primarily where you can drain the water.

Part A, the Inner Cannula, is comprised of multiple tiny holes along the bottom and mid way up the container. These holes facilitate the straining process. It stands about 1½ inches off of the base of Part B. This also encourages better draining. Part A can hold 30-40 crawfish. The Inner Cannula is removable and can be replaced by additional Inner Cannula's so that as many batches of crawfish can be soaked/cleaned as the user prefers. It sits in Part B and has a spout that makes pouring into a cooking basket easier.

Part B is solid rectangular structure that contains Part A. It has a single hole for draining. This hole can be closed when the need to soak the seafood arises.

Once the user has completed using the Seafood Spitter, clean up is simple as it only requires soap and water.

Part A is simply a sieve like structure comprised of multiple tiny holes along the bottom and midway up the container. These holes facilitate the straining process required when removed from Part B. The sieve can be removed and replaced by additional sieves.

Part A is housed securely in Part B and has a spout conveniently molded on the upper edge of both Part A and Part B to facilitate cleaning and accurate pouring.

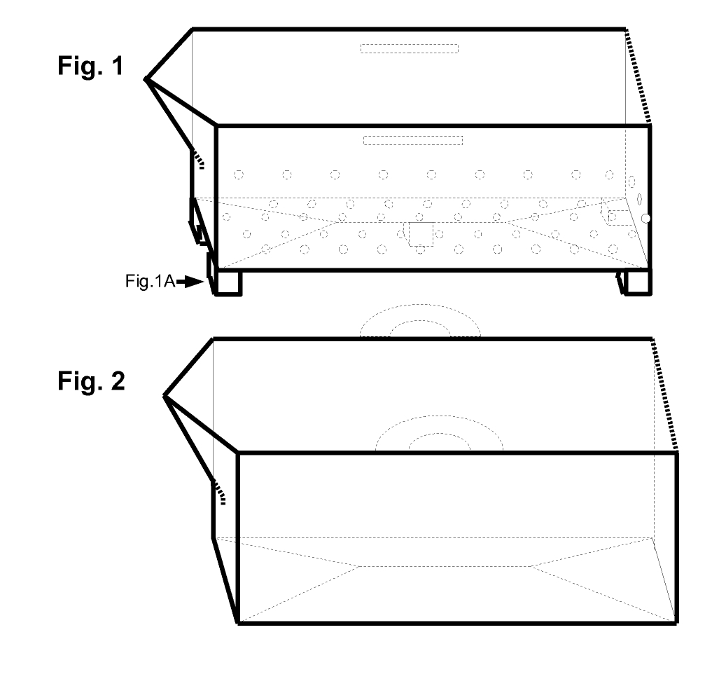

FIG. 1: Part A: is a lateral side view of the Sieve with Spout—This Sieve sits in Part B which is the outer basket.

FIG. 1A: Feet of the sieve.—There are five feet located at the bottom of the sieve; four at each corner and one in the center of the basket. The feet assist with the draining of liquids and keep the basket elevated from sediment from Part B.

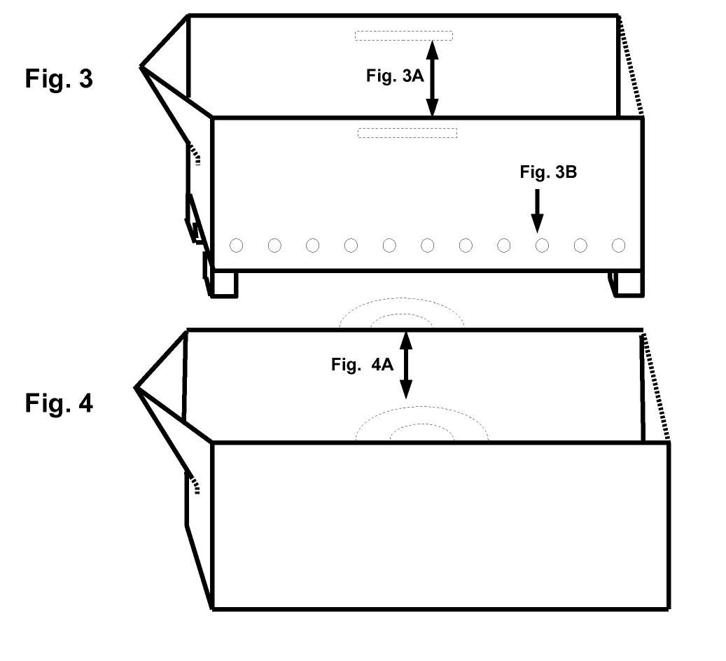

FIG. 3: This is a horizontal/lateral side view of the sieve with spout, showing multiple holes that help facilitate better draining of waste/liquid. This side view also shows the handles.

FIG. 3A: Handles—Are attached to the inner basket/sieve to assist with lifting.

FIG. 3B: The holes located horizontally and/or vertically on the sieve. Again, these are the holes located in the inner basket.

Part B is the horizontal/side view of the structure with spout that houses part A

FIG. 2: Part B is the outer container (receptacle), designed to securely house FIG. 1 showing a horizontal vertical view.

FIG. 4: Part B is the outside/side view of the container (receptacle).

FIG. 4A: Handles-handles that are located on the top of the container used for easy lifting.

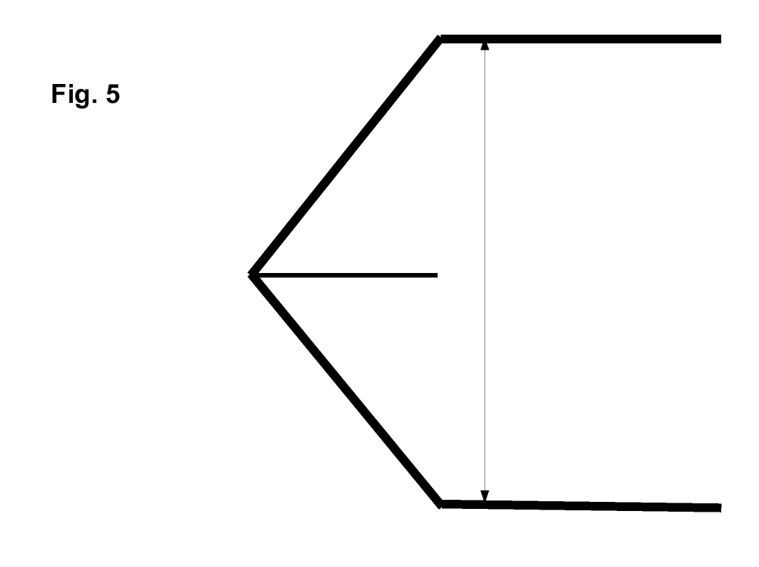

FIG. 5: This is a top view of the spout that will be built in the Sieve and Container used for pouring. The Spout extends the entire length of the front edge (section) of the Sieve and Container.

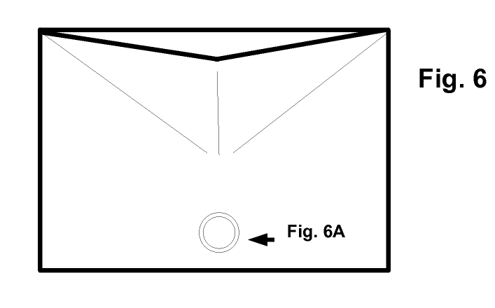

FIG. 6: Front Part of B is the front view of the Container/outer basket with a draining spout located at the bottom front middle that liquids and sediment will drain/exit.

FIG. 6A: This is a front view of the hole/spout in the container (outer basket) for draining.

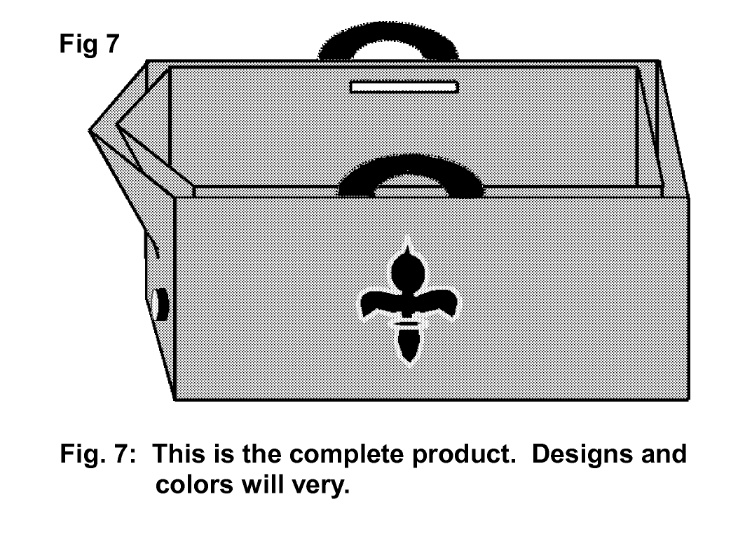

FIG. 7: This is a color side horizontal view of the Sieve inside the Container (Outer Basket) and how the Part A and Part fits together as a complete package.

1. What is claimed is a useful container (utility and or mechanism) for cleaning and draining?
